(19) United States
(12) Patent Application Publication
(10) Pub. No.: US 2016/0159227 A1
(43) Pub. Date: Jun. 9, 2016

(54) WIRELESS CHARGING DEVICE FOR CHARGING A BATTERY OF A VEHICLE

(71) Applicant: ZF FRIEDRICHSHAFEN AG, Friedrichshafen (DE)

(72) Inventor: Matthias LOCHNER, Bindlach (DE)

(73) Assignee: ZF Friedrichshafen AG, Friedrichshafen (DE)

(21) Appl. No.: 14/906,392

(22) PCT Filed: Jun. 23, 2014
(86) PCT No.: PCT/EP2014/063084

§ 371 Date: Jan. 20, 2016

(30) Foreign Application Priority Data
Jul. 22, 2013 (DE) 10 2013 214 311.7

(51) Int. Cl. B60L 11/18; F16N 31/00

(52) U.S. Cl. CPC B60L 11/182; F16N 31/006

(57) ABSTRACT

The invention relates to a vehicle having a battery and a vehicle coil for wireless receiving a charging current for the battery, wherein the vehicle coil is integrated into the base plate of a transmission oil pan.

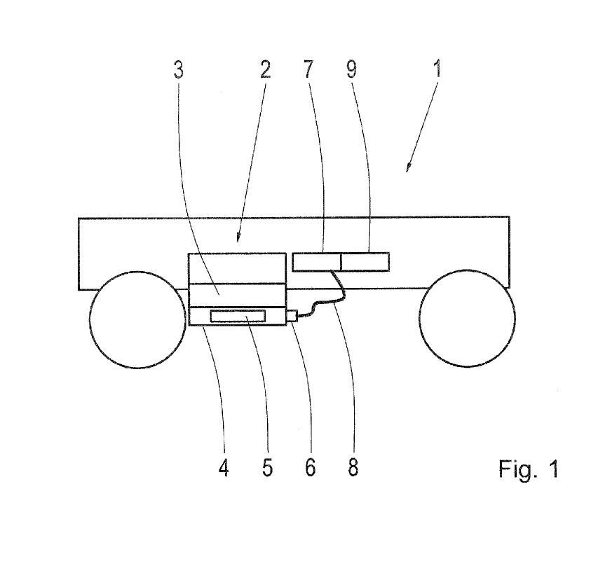

The present disclosure relates to a vehicle according to the preamble of claim 1.

It is also possible not to transmit the energy inductively, but rather to transmit the energy by highly resonant systems using a resonant circuit. Here, a matching network for the oscillator frequency is used.

In the wireless charging of batteries of electric vehicles, the transmission of electrical energy is carried out by the transformer principle through an air gap between a first coil which is located in the vehicle, and a second coil which is assigned to a charging station. In this case, on the vehicle side are usually required additional power electronics, such as e.g. a rectifier and current and voltage regulator. Buck-boost converter or step-down converters, which usually comprise inductors for the storage of the electric current, are specifically used to adapt the charging current or the charging voltage to the battery.

Documents U.S. Pat. No. 4,496,896 A1 and DE 10 2011 010 049 A1 describe a device for charging a battery of a vehicle in which the electric energy for charging the battery is inductively transmitted between a coil in the vehicle and a coil in the charging station.

Furthermore, from the final report of the joint project “Wireless Charging of Electric Vehicles” as part of the R & D program “Promotion of research and development in the field of electric mobility” from October 2011 (http://www.erneuerbar-mobile.de/projekte/foerderprojekte-aus-dem-konjunkturpaket-ii-2009-2011/pkw-feldversucke/abschlussbericht-conductix.pdf) it is known that the on-vehicle charging coil can be installed in the underbody panelling of a vehicle.

A disadvantage in the prior art has been found that the on-vehicle charging coil is installed as an additional component in the underbody paneling of a vehicle. This is a reduction of the ground clearance of the vehicle and it leads to an adverse change in the air resistance.

The technical task of the present disclosure is to provide a vehicle in which the integration of the charging coil has no adverse effect on the driving behavior of the vehicle.

This task is resolved with the subject of the applicable claim 1. Advantageous embodiments of the present disclosure are the subject of dependent claims.

According to the present disclosure, the vehicle has a battery and a vehicle coil for wireless receiving a charging current for the battery. Suitably, the charging current can be received inductively or by high resonance. The vehicle coil is integrated into the base plate of a transmission oil pan. The coil may be designed as a vehicle sensor or antenna.

In one embodiment of the present disclosure, the vehicle coil is integrated by insert molding in the bottom plate of the transmission oil pan. In other words, in the manufacturing process of the bottom plate of the transmission oil pan the vehicle coil is encapsulated. In this case a plastic is suitably used.

One advantage of the present disclosure is that no additional components need to be installed because the vehicle coil is installed as an integral component and requires no extra space in the bottom of the transmission oil pan. In addition, the ground clearance of the vehicle is not changed by the integral obstruction of the vehicle coil, whereby the air resistance is not affected at the same time.

A further advantage is that the necessary distance of the vehicle coil to metallic, absorbing housing parts of the vehicle is ensured by integrating the vehicle coil in the bottom plate of the transmission oil pan. There is thus prevented any EMC interference during the operation of the vehicle coil. At the same time, the components, e.g. pressure regulator, parking brake magnet, electrical modules of the transmission covered by the transmission oil pan, are protected against electromagnetic interference caused by the vehicle coil while driving, i.e. when the vehicle coil is not in operation so that no charging operation takes place.

Of course, terminals can be provided on the transmission oil pan to which an existing power electronics and battery installed in the vehicle can be connected with the vehicle coil via power and data lines.

The present disclosure will now be explained in more detail using a schematic FIGURE.

The single FIGURE shows a schematic representation of a vehicle 1 on a trafficable surface. In the area of the transmission 2 is located the transmission oil pan 3. The transmission oil pan 3 comprises a bottom plate 4. In this bottom plate 4 is integrated the vehicle coil 5. The transmission oil pan 4 also has connections 6, to which are connected power electronics 8 and a battery 9 by means of power and data connection cables 7.

### REFERENCE NUMERALS

1 Vehicle

2 Transmission

3 Transmission oil pan

4 Bottom plate

5 Vehicle coil

6 Terminal

7 Power electronics

8 Connection line

9 Battery

1. A vehicle comprising:
a battery and
a vehicle coil configured for wireless receiving a charging current for the battery, wherein the vehicle coil is integrated in a base plate of a transmission oil pan.

2. The vehicle according to claim 1, wherein the vehicle coil is integrated into the base plate of the transmission oil pan by insert molding.

3. The vehicle according to claim 2, wherein the vehicle coil is encapsulated by insert molding with a plastic.

4. The vehicle according to claim 1, wherein the vehicle coil is a sensor or an antenna.

5. The vehicle according to claim 1, wherein the vehicle coil is connected by power and data lines to the battery and power electronics.

6. The vehicle according to claim 5, wherein the power electronics include at least one of a rectifier and a current and voltage regulator.

7. The vehicle according to claim 1, wherein the vehicle coil does not affect an air resistance of the vehicle.

8. The vehicle according to claim 1, wherein the vehicle coil does not affect a ground clearance of the vehicle.

9. The vehicle according to claim 1, wherein the vehicle coil wireless receives the charging current inductively or by high resonance.

10. The vehicle according to claim 1, wherein the integration of the vehicle coil into the transmission oil pan does not reduce an available volume within the transmission oil pan.

11. The vehicle according to claim 1, wherein the integration of the vehicle coil into the transmission oil pan prevents electromagnetic interference during an operation of the vehicle coil.

12. The vehicle according to claim 11, wherein the integration of the vehicle coil into the transmission oil pan prevents electromagnetic interference between the vehicle coil and electronic components.

13. The vehicle according to claim 12, wherein the electronic components include at least one of a pressure regulator, a parking brake magnet, and an electrical module of a transmission.

14. The vehicle according to claim 1, wherein the integration of the vehicle coil into the transmission oil pan prevents charging taking place when the vehicle coil is not in operation.

15. A transmission oil pan comprising:
a base plate; and
a vehicle coil configured for wireless receiving a charging current for a battery, wherein the vehicle coil is integrated in the base plate.

16. The transmission oil pan according to claim 15, wherein the vehicle coil is integrated into the base plate by insert molding.

17. The transmission oil pan according to claim 16, wherein the vehicle coil is encapsulated by insert molding with a plastic.

18. The transmission oil pan according to claim 15, wherein the vehicle coil is a sensor or an antenna.

19. The transmission oil pan according to claim 15, wherein the vehicle coil is connected by power and data lines to a battery and power electronics.

20. The transmission oil pan according to claim 19, wherein the power electronics include at least one of a rectifier and a current and voltage regulator.
